(19) United States
(12) Patent Application Publication
(10) Pub. No.: US 2017/0250024 A1
(43) Pub. Date: Aug. 31, 2017

(54) Rare-Earth-Free Permanent Magnetic Materials Based on Fe-Ni

(71) Applicants: Northeastern University, Boston, MA (US); The Trustees of Columbia University in the City of New York, New York, NY (US)

(72) Inventors: Laura H. LEWIS, Boston, MA (US); Katayun BARMAK VAZIRI, White Plains, NY (US)

(21) Appl. No.: 15/508,341

(22) PCT Filed: Sep. 2, 2015
(86) PCT No.: PCT/US2015/048145

§ 371 Date: Mar. 2, 2017

Related U.S. Application Data
(60) Provisional application No. 62/044,564, filed on Sep. 2, 2014.
(60) Provisional application No. 62/168,298, filed on May 29, 2015.

(51) Int. Cl. H01F 41/02; H01F 7/02; C22C 33/02; C08K 5/109; B22F 1/00; C22C 19/03; H01F 1/147; C22C 38/08

(52) U.S. Cl. CPC H01F 41/0253; H01F 1/14708; H01F 1/14733; H01F 7/02; C22C 38/08; C08K 5/109; B22F 1/0018; C22C 19/03; C22C 33/02; C22C 2202/02

(57) ABSTRACT

The invention provides high coercivity magnetic materials based on FeNi alloys having an L1₀ phase structure, and methods for making the materials.

### STATEMENT REGARDING FEDERALLY SPONSORED RESEARCH OR DEVELOPMENT

The invention was developed with financial support from ARPA-E Grant No. 0472-1537 from the U.S. Department of Energy and Grant No. CMMI-1129433 from the National Science Foundation. The U.S. Government has certain rights in the invention.

### BACKGROUND

Magnetic materials are indispensable to modern life and are present in advanced devices and motors of every kind. They facilitate the conversion of electrical to mechanical energy, transmit and distribute electric power, and provide the basis for data storage systems. In particular advanced permanent magnets, which maintain a large magnetic flux in the absence of a magnetizing field, underlie the operation of generators, alternators, eddy current brakes, motors, relays and actuators by converting mechanical energy to electrical energy or vice versa. The strength of a permanent magnet is quantified by the maximum energy product (BH)ₘₐₓ, a figure of merit calculated as the optimal product of the magnetic induction, B, and the applied field, H, in the second quadrant of the (B-H) hysteresis (demagnetization) loop. The world's strongest “supermagnets”, based on the rare-earth (RE)-based intermetallic compound RE₂Fe₁₄B, can exhibit energy products on the order of 56 MGOe, with remanences of about 14 kG and intrinsic coercivities of about 10 kOe. These supermagnets derive their superior properties from the high magnetization provided by the transition metal sublattice and the extremely strong magnetocrystalline anisotropy field HK donated by spin-orbit coupling of the RE 4f electrons. However, given the scarcity and expense of RE materials, there is a need to develop new materials for high performance permanent magnets.

Compounds of tetragonal crystal symmetry with L1₀ structure such as FePt and FePd possess high magnetization and significant magnetocrystalline anisotropy, derived from the lower-symmetry crystal structure, necessary for advanced permanent magnet applications. However, the costliness of Pt and Pd preclude their use as components in bulk permanent magnets for motors and generators. The isoelectronic composition FeNi, on the other hand, contains much less expensive and readily available constituents. Importantly, formation of FeNi in the L1₀ structure has recently been observed under certain conditions in the laboratory as well as in selected meteorites, and is confirmed to exhibit a high magnetization (1.6 T—equivalent to Nd₂Fe₁₄B) and high anisotropy. Therefore, it would be very advantageous to develop methods of preparing FeNi material having L1₀ structure.

### SUMMARY OF THE INVENTION

The invention provides high coercivity magnetic materials (chemically ordered compounds) based on FeNi alloys having an L1₀ phase structure, and methods for making the materials. The methods include providing severe plastic deformation and annealing at below the chemical ordering temperature expected for the L1₀ phase of the FeNi alloy in an environment that prevents oxidation of the alloy material.

One aspect of the invention is a method of making a magnetic FeNi ordered compound. The method includes the steps of: (a) preparing a melt containing Fe, Ni, and optionally one or more elements selected from the group consisting of Ti, V, Al, B, and C, wherein the ratio of elements in the melt is according to the formula Fe_{(0.5-a)}Ni_{(0.5-b)}X_{(a+b)}, wherein X is Ti, V, Al, B, or C, and wherein 0≦(a+b)<0.1; (b) cooling the melt to yield a solid form of an FeNi alloy material; (c) subjecting the solid form to a severe plastic deformation process performed below a chemical ordering temperature of the desired L1₀ phase to yield a deformed FeNi alloy material; and (d) annealing the deformed FeNi alloy material in a reduced oxygen environment at a temperature below the chemical ordering temperature of the desired L1₀ phase for a period of time from hours to months, whereby L1₀ structure is formed to yield the magnetic FeNi ordered compound.

Another aspect of the invention is a magnetic FeNi ordered compound produced by the method described above. In certain embodiments, the ordered compound material contains at least 50% by weight in the form of L1₀ structure, or at least 90% by weight in the form of L1₀ structure.

Yet another aspect of the invention is a magnetic FeNi ordered compound having the formula Fe_{(0.5-a)}Ni_{(0.5-b)}X_{(a+b)}, wherein X is Ti, V, Al, B, or C, wherein 0<(a+b)<0.1, and wherein the ordered compound comprises L1₀ structure. In certain embodiments, the ordered compound material contains at least 50% by weight in the form of L1₀ structure, or at least 90% by weight in the form of L1₀ structure.

Still another aspect of the invention is a permanent magnet comprising an FeNi ordered compound as described above.

The invention is further summarized by the following list of items:

1. A method of making a magnetic FeNi ordered compound, the method comprising the steps of:

(a) preparing a melt comprising Fe, Ni, and optionally one or more elements selected from the group consisting of Ti, V, Al, B, and C, wherein the ratio of elements in the melt is according to the formula Fe_{(0.5-a)}Ni_{(0.5-b)}X_{(a+b)}, wherein X is Ti, V, Al, S, P, Nb, Mo, B, or C, and wherein 0≦(a+b)<0.1;

(b) cooling the melt to yield a solid form of an FeNi alloy material;

(c) subjecting the solid form to a severe plastic deformation process performed below a chemical ordering temperature of the desired L1₀ phase to yield a deformed FeNi alloy material; and

(d) annealing the deformed FeNi alloy material in a reduced oxygen environment at a temperature below the chemical ordering temperature of the desired L1₀ phase for a period of time from hours to months, whereby L1₀ structure is formed to yield the magnetic FeNi ordered compound.

2. The method of item 1, wherein the melt in step (a) consists essentially of Fe and Ni.
3. The method of item 1 or item 2, wherein the melt in step (a) consists essentially of Fe, Ni, and one or more elements selected from the group consisting of Ti, V, Al, S, P, Nb, Mo, B, and C.
4. The method of any of items 1-3, wherein step (b) comprises melt spinning and yields a solid form comprising pieces suitable for milling.
5. The method of any of items 1-4, wherein the severe plastic deformation process comprises mechanically milling the solid form in the presence of a surfactant and in a reduced oxygen environment to form a powder, wherein the powder comprises a plurality of particles having a size in the nanometer to micrometer range.
6. The method of item 5, wherein the mechanical milling is carried out in the presence of a cryogen.
7. The method of item 6, wherein the cryogen is liquid nitrogen, liquid argon, or liquid helium.
8. The method of any of items 5-7, wherein the surfactant is oleic acid.
9. The method of any of items 1-8, wherein the severe plastic deformation process comprises cold rolling.
10. The method of any of items 1-9, wherein the severe plastic deformation and/or annealing steps are performed at a temperature in the range from about 310° K to about 600° K.
11. The method of any of items 1-10, wherein the FeNi ordered compound resulting from step (d) is in a form of, or is further processed to result in a form of, a powder comprising a plurality of particles having a size in the nanometer range, or in the micrometer range, or a mixture thereof.
12. The method of item 11, further comprising compressing the particles in the presence of a magnetic field to form a composite magnetic composition.
13. The method of any of items 1-12, further comprising, prior to performing step (d), the step of: (c1) milling the deformed FeNi alloy from step (c) to form a powder comprising a plurality of particles having a size in the nanometer range, or in the micrometer range, or a mixture thereof.
14. The method of any of items 1-13, wherein the annealing is carried out in the presence of a magnetic field.
15. The method of item 14, wherein the magnetic field has a magnitude in the range from about 10 G to about 100000 G.
16. A magnetic FeNi ordered compound produced by the method of any of the preceding items.
17. The ordered compound of item 16, wherein at least 50% of the ordered compound by weight is in the form of L1₀ structure.
18. The ordered compound of item 17, wherein at least 90% of the ordered compound by weight is in the form of L1₀ structure.
19. A magnetic FeNi ordered compound having the formula Fe_{(0.5-a)}Ni_{(0.5-b)}X_{(a+b)}, wherein X is Ti, V, Al, S, P, Nb, Mo, B, or C, wherein 0<(a+b)<0.1, and wherein the ordered compound comprises L1₀ structure.
20. The ordered compound of item 19, wherein at least 50% of the ordered compound by weight is in the form of L1₀ structure.
21. The ordered compound of item 20, wherein at least 90% of the ordered compound by weight is in the form of L1₀ structure.
22. The ordered compound of any of items 19-21, which has a coercivity of at least about 5 kOe
23. The ordered compound of any of items 19-22, which has a coercivity in the range from about 5 kOe to about 30 kOe.
24. A permanent magnet comprising the FeNi ordered compound of any of items 19-23.

### BRIEF DESCRIPTION OF THE DRAWINGS

FIG. 1 shows a schematic illustration of a metal alloy having L1₀ structure. Atoms of two different elements are shown as empty and filled spheres. Dimensions of the fct lattice are shown as a, b, and c.

FIG. 2 shows the results of synchrotron X-ray diffraction of an FeNi alloy sample obtained by melt spinning, cryomilling, and (in the upper curve) low temperature annealing. Diffraction Bragg peak splitting can be seen in the annealed sample. X-ray diffraction data for meteorite L1₀ FeNi tetrataenite (smooth curve at bottom) are shown for reference (Albertsen, Physica Scripta 23.3 (1981):3011981).

FIG. 3 shows neutron diffraction data for a cold-rolled FeNi and annealed alloy sample of the invention. The observed data are shown as circles, and the calculated pattern from a Reitveld refinement as a solid curve. The difference between the observed and calculated patterns is shown at the bottom.

FIG. 4 shows neutron diffraction data for a cold-rolled and annealed FeNi(Ti) alloy sample of the invention. The observed data are shown as circles, and the calculated pattern from a Reitveld refinement as a solid curve. The difference between the observed and calculated patterns is shown at the bottom.

FIG. 5 shows neutron diffraction data for a cryomilled and annealed FeNi(Ti) alloy sample of the invention. The observed data are shown as circles, and the calculated pattern from a Reitveld refinement as a solid curve. The difference between the observed and calculated patterns is shown at the bottom.

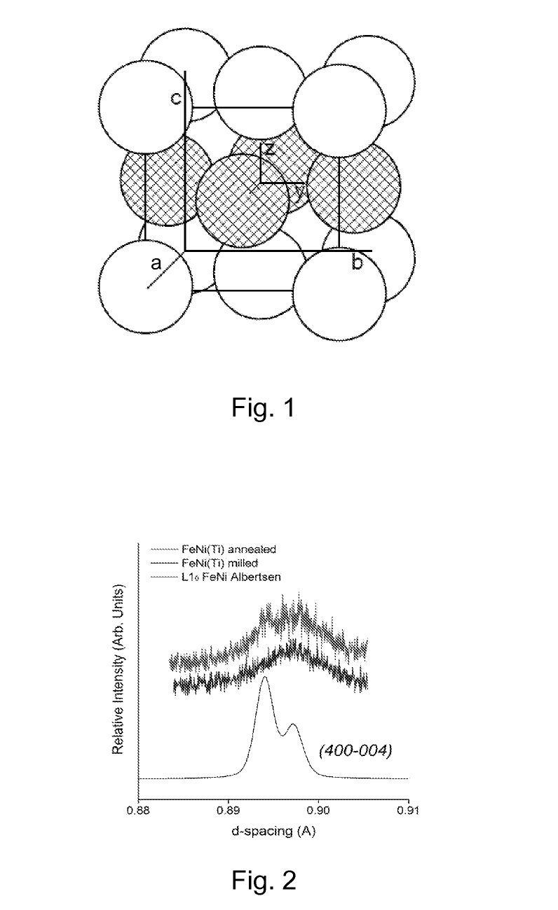

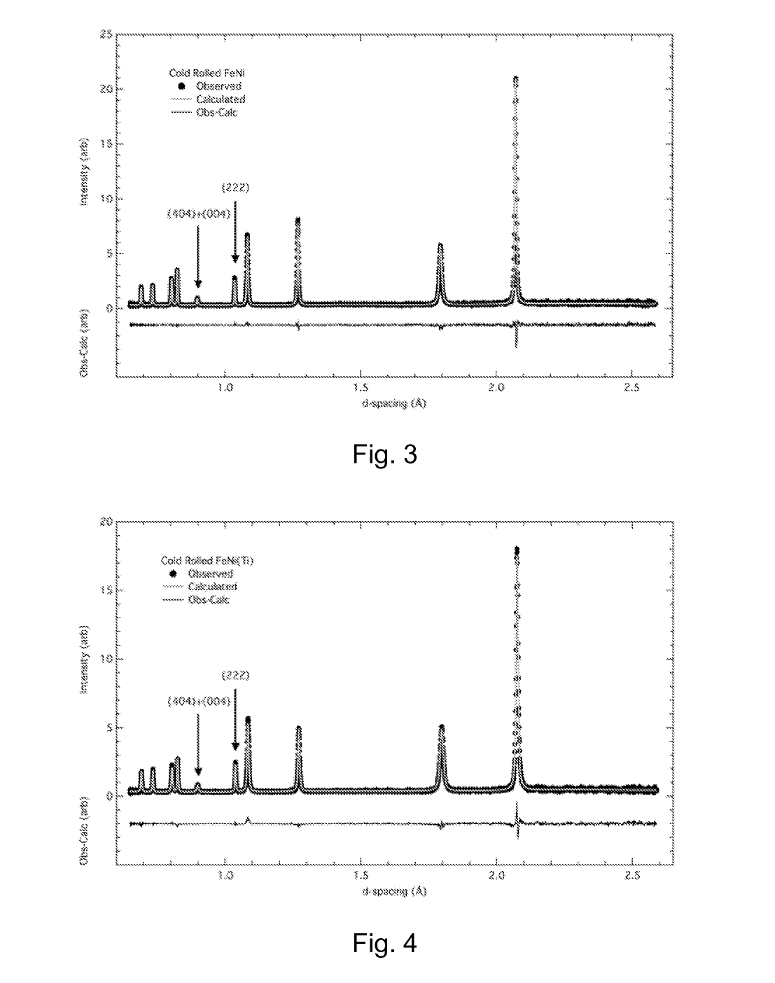

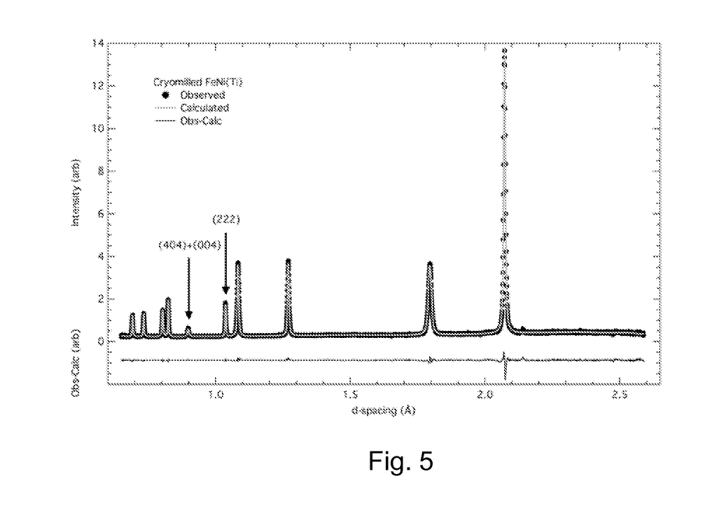

### DETAILED DESCRIPTION OF THE INVENTION

The invention provides a method of fabricating an FeNi alloy having the L1₀-type crystal structure, i.e., and ordered compound also referred to as “tetrataenite”. This structure has recently been observed under certain conditions in the laboratory as well as in selected iron-nickel meteorites. Tetrataenite possesses a high magnetization (1.6 T, equivalent to Nd₂Fe₁₄B) and high anisotropy. However, it exhibits a low chemical ordering temperature of 320° C., indicating that the order-to-disorder transformation in FeNi is kinetically limited on account of low atomic mobilities at temperatures below the ordering temperature. The invention correlates the structure, phase stability, and magnetic response of both substitutional (e.g., Ti, V, Al) and interstitial (e.g., B and C) additions of atoms into the FeNi crystal lattice to stabilize the chemical ordering. Other elements, including S, P, Nb, and Mo, may also be included as either substitutional or interstitial additions. The invention achieves an economical, advanced permanent magnetic material that is not based on and preferably does not contain rare earth elements.

One aspect of the invention is a nanostructured magnetic alloy composition. The composition contains an alloy of the general formula Fe_{(0.5-a)}Ni_{(0.5-b)}X_{(a+b)}. The FeNi lattice is substituted with an element, X, which can be, for example, Ti, V, Al, S, P, Nb, Mo, B, or C. The amount of X substituted into the FeNi lattice is not more than 10% on a mole fraction basis (i.e, 0<(a+b)<0.1; or in some embodiments, 0<(a+b)<0.1, meaning that in such embodiments substitutions with X are optional). The composition contains L1₀ phase structure. Another aspect of the invention is a permanent magnet containing the magnetic FeNi ordered compound composition of the invention.

Among the various sources of magnetic anisotropy, including magnetocrystalline, shape, and stress, magnetocrystalline anisotropy provides the largest anisotropy and is thus the favored mechanism to induce coercivity in high-energy permanent magnets. The production of rare-earth-free permanent magnetic materials with high-energy products (BH)ₘₐₓ requires that the principle source of the exceptional anisotropy, the magnetocrystalline anisotropy arising from the 4f electronic state, is no longer available for exploitation. This magnetocrystalline anisotropy is recovered in the magnetic materials of the present invention in that the materials adopt a low symmetry crystal structure, such as hexagonal or tetragonal crystal structures. In low-symmetry crystal structures, the material's magnetic moment may align perpendicular to the basal plane direction, providing two energy minima for the magnetization that define the uniaxial magnetic anisotropy state. The majority of strongly-magnetic transition-metal alloys assume a high-symmetry cubic structure that displays low magnetocrystalline anisotropy. The materials of the present invention, however, exploit the structural and magnetic attributes of the L1₀ family of transition-metal-based materials, specifically FeNi with ternary alloying additions.

The L1₀ structure is a face-centered tetragonal (fct) crystal lattice structure that forms in equiatomic or nearly equiatomic compounds AB, and consists of alternating layers of the two constituent elements A and B stacked in a direction parallel to the tetragonal c-axis, creating a natural superlattice. In the case of L1₀ structure of FeNi alloy, the superstructure consists of alternating monoatomic layers of Fe and Ni along the c-axis direction. FeNi alloy having L1₀ structure exists as an equilibrium state below the chemical ordering temperature of 320° C. In FeNi alloys of the present invention, individual atoms of substitutional elements such as Ti, V, and Al can substitute for either Fe or Ni atoms in the L1₀ lattice, and individual atoms of interstitial addition elements such as B or C can be interspersed within the regular lattice structure.

The invention includes a method of making a tetragonal, chemically-ordered magnetic alloy based on the FeNi composition described above. The method includes the steps of: (1) preparing a melt containing Fe, Ni, and optionally one or more elements selected from the group consisting of Ti, V, Al, or the group consisting of Ti, V, Al, Nb, Mo, S, and P. The alloy also may be made without those elements. Conditions for preparing a melt including any combination of these elements are well known in the art, and any known method can be employed. The ratio of elements in the melt follows the formula Fe_{(0.5-a)}Ni_{(0.5-b)}X_{(a+b)}, wherein X can be one or more of Ti, V, Al, or one or more of Ti, V, Al, Nb, Mo, S, and P, and wherein 0<(a+b)<0.1; (2) homogenizing and then cooling the melt to achieve a solid homogeneous form; (3) subjecting the solid homogeneous form to high strain processing (also referred to as “severe plastic deformation”) performed at a temperature below the chemical ordering temperature of the L1₀ phase of the alloy; and (4) annealing the deformed material at a temperature below the chemical ordering temperature of the L1₀ phase of the alloy for a long period of time (hours, days, weeks, or months). In step (2), the melt can be formed, processed, and cooled by any known method so as to obtain a solid form that is suitable for further processing. The cooling process should result in sufficiently small pieces (e.g., formed by melt spinning) so that milling can be used conveniently to obtain a powder containing small particles (e.g., particles in the micrometer range (1-1000 microns in largest dimension) and/or in the nanometer range (1-999 nm in largest dimension). At least steps (3) and (4) are performed in an oxygen-depleted environment, such as an environment saturated with nitrogen, argon, or helium, in gas or liquid form depending on the temperature requirements of the step.

Severe plastic deformation (SPD) refers to a family of metal processing techniques that convey a complex stress state or high shear state to a material via the generation of a high density of lattice defects. This type of processing delivers excess energy that is stored in the formation of non-equilibrium defects to cause a permanent change of shape in a material that is related to the breaking and rearrangement of interatomic bonds. SPD allows the generation and motion of crystalline defects that can include 0-dimensional lattice defects, such as lattice vacancies or lattice distortions; 1-dimensional lattice defects, such as lattice dislocations; and 2-dimensional lattice defects, such as crystallite surfaces and grain boundaries. The family of SPD techniques includes, but is not limited to: mechanical milling, mechanical alloying (including cryomilling), rolling (especially cold rolling), accumulative roll bonding, extrusion processes including equal channel angular extrusion, high pressure torsion, and repetitive corrugation and straightening. See, e.g., Valiev, Ruslan Zafarovich, Rinat K. Islamgaliev, and Igor V. Alexandrov. “Bulk nanostructured materials from severe plastic deformation.” Progress in Materials Science 45.2 (2000): 103-189; and Azushima, A., et al. “Severe plastic deformation (SPD) processes for metals.” CIRP Annals-Manufacturing Technology 57.2 (2008): 716-735. Preferred SPD methods include cryomilling and cold rolling. In the cryomilling methods (also referred to as cryogenic grinding), a slurry of metal powder is mechanically milled as a slurry in a cryogen, such as liquid nitrogen. In the cold rolling method, the metal sample is passed between one or more pairs of rolls whereupon it is highly reduced in thickness and increased in area, nominally conserving the sample volume. In cold rolling, the temperature of the material is maintained below the recrystallization temperature or chemical ordering temperature of the material.

The important step of annealing can be performed before or after the step of SPD, or both before and after SPD. The conditions for annealing are dependent on the combination of time and temperature. Lower annealing temperature (e.g., ambient temperature) requires a longer period of annealing, such as weeks, months, or even years. Higher annealing temperatures, up to but not exceeding the chemical ordering temperature, will reduce the time required for annealing, such as to days or weeks. In general, annealing preferably is performed for a period of about 1, 2, 3, 4, 5, 6, 7, 8, 9, 10, 12, 15, 20, 24, 28, 30, 35, or 40 weeks or more, and at a temperature of about 20, 25, 30, 40, 50, 60, 70, 80, 100, 120, 150, 200, 220, 240, 250, 260, 270, 280, 290, 300, or 310° C. The temperature can vary or be held constant during the annealing period.

The final resulting FeNi chemically ordered compound contains at least 20%, 30%, 40%, 50%, 60%, 70%, 80%, 85%, 90%, 95%, 98%, or 99% L1₀ phase and is magnetic. Preferably, the compound has a high coercivity and is permanently magnetic. The coercivity can be, for example, at least 500, 600, 700, 800, 900, 1000, 1200, or 1500 kOe, or can have a coercivity in the range from about 500 kOe or from about 1000 kOe to about 10000, 15000, 20000, 25000, 30000, 40000, or 50000 kOe. The compound can be in any physical form, such as a powder, composite, nanocomposite, or in solid form. If in powdered form, it can be compressed to form a compact, preferably in the presence of a magnetic field, to form a permanent magnet of any desired size and shape.

### EXAMPLES

### Example 1. Synthesis and Cold Deformation Processing of FeNi Alloys

Cold-deformation of FeNi alloys delivered by cold-rolling was performed, and the resulting materials were characterized. The alloy synthesis, processing, and characterization were performed at the Materials Preparation Center at the Ames Laboratory, U.S. Department of Energy. Two cylindrical FeNi-based alloys (diameter 1 cm, L≈10 cm) with nominal compositions Fe₅₀Ni₅₀ and Fe₄₉Ni₄₉Ti₂ were synthesized by drop-casting. The final compositions of the as-cast alloys, evaluated through X-ray fluorescence (XRF), were determined to be Fe_{53.6}Ni_{46.4} and Fe_{52.4}Ni_{45.8}Ti_{1.8}. Chemical homogeneity was confirmed.

As evidenced from X-ray diffraction (XRD) analysis using Cu Kα radiation in the as-cast state, both alloys exhibited an fcc crystal structure. The lattice parameter calculated for this fcc phase in the binary alloy, 3.587±0.003 Å, was consistent with that reported in the literature for a Fe_{53.6}Ni_{46.4} composition. The addition of Ti slightly increased the lattice parameter to a value of 3.597±0.006 Å. To guarantee phase homogeneity before severe plastic deformation processing was performed, both alloys were annealed for 100 h at 500° C. (a temperature at which a single fcc phase is expected). For the annealing process, samples were wrapped in tantalum and sealed independently in evacuated quartz tubes. The Ta foil was used as a getter of residual oxygen to prevent alloy oxidation. After annealing, a disk was cut out from the middle of the samples for XRD analysis. The annealing process yielded a single fcc phase in both alloys, with lattice parameters of 3.586±0.004 Å for the binary composition and 3.593±0.004 Å for the ternary alloy including Ti.

After annealing, the samples were prepared for plastic deformation via cold-rolling. For this, the sample must have two flat parallel surfaces in order to guarantee an even distribution of the applied load. Therefore, rectangular pieces with a thickness of ˜2 mm were cut from the cylindrical samples by electrical discharge machining. These slices were then used for cold-rolling, which was performed gradually in 13 steps, after which the material no longer could be deformed. The applied load in this process varied from 0.6 Tons on the first pass to 35.6 Tons on the last. The percentage of cold-work, defined in terms of the initial (t₀) and final (t_{f}) thickness as % CW=(t₀−t_{f})/t₀, was 85.63% for the binary FeNi composition and 82.93% for the FeNiTi sample. After deformation, samples were sealed in evacuated quartz tubes and annealed at 290° C. for 6 weeks.

### Example 2. Characterization of Cold-Rolled FeNi Alloys

X-ray diffraction (XRD) using Cu radiation for the cold-rolled samples produced in Example 1 provided evidence of the existence, in each sample, of two different fcc phases. One of the phases exhibited very broad XRD peaks, while the other one, with Bragg reflections at higher 20 values, had sharper and higher intensity peaks. Calorimetry performed on the FeNi sample prior to cold-rolling demonstrated a transition at 507.2±3° C. analogous to its Curie temperature. This temperature is in agreement with that reported for an fcc FeNi alloy slightly off-equiatomic towards higher Fe contents. The FeNi(Ti) sample, on the other hand, did not exhibit a well-defined Curie transition. The cold-rolled alloys exhibited several thermal features. First, they showed two low-temperature (T<400° C.) broad exotherms associated with the annealing of structural defects, just as in the case of the cryomilled powders. Second, a very broad high-temperature exothermic transition in the range 400° C.<T<600° C. was also observed for these cold-rolled samples, but was unexplained. The FeNi cold-rolled sample did exhibit a clear Curie transition at 507.7° C., consistent with that of the starting FeNi alloy.

### Example 3. Effect of Annealing as Shown by X-Ray Diffraction

The effect of post-processing annealing on FeNi alloys made by cryomilling was investigated by X-ray diffraction. The data indicated that the annealing step produced the desired tetragonal lattice structure (L1₀) of FeNi, i.e., tetrataenite.

Pieces of solidified FeNi were mechanically milled in a liquid nitrogen bath (Spex SamplePrep 6770 Freezer/Mill) to guarantee that the processing temperature remained below the equilibrium FeNi order-disorder temperature of 320° C. Stainless steel vials were loaded with ˜1 g of cut ribbons, and a surfactant mixture of oleic acid (25 wt %) mixed in heptane (25 wt %) was added to minimize sample oxidation. A magnetically driven stainless steel impactor was used to produce the milling action. The vials were loaded and sealed inside a glovebox under an argon atmosphere. The cryomilling cycle included 10 min of active milling at a rate of 15 cycles/s followed by 2 min of cooling, to obtain cumulative milling times of 9 h. Samples, in powder form, were then collected and rinsed with heptane and acetone in order to remove the surfactants. Post deformation annealing was as described in Example 1.

FIG. 2 shows synchrotron x-ray diffraction data collected on a sample of powder subjected to a cryomilling procedure both before and after the annealing step. It is considered that the diffracted Bragg peaks associated with the set of (004) crystallographic planes in the cubic structure split into pairs of peaks with Miller indices (004) and (400) in the tetragonal structure. The data of FIG. 2 confirms the presence of a single (004) peak before annealing and a doubled (004)-(400) peak after annealing. X-ray diffraction data obtained from meteorite-derived tetrataenite [Albertsen, J. F. “Tetragonal lattice of tetrataenite (ordered Fe—Ni, 50-50) from 4 meteorites.” Physica Scripta 23.3 (1981): 301.] that illustrates the tetragonal (004)-(400) Bragg peak split is included in FIG. 2 for comparison.

### Example 4. Characterization of Tetragonality of FeNi Alloys by Neutron Diffraction

Samples produced by cold-rolling and cryomilling, with and without final annealing below the chemical ordering temperature, were examined at the High Resolution Powder Diffractometer (HRPD) at the ISIS facility at the Science and Technology Facilities Council Rutherford Appleton Laboratory, UK. The HRPD possesses the resolution to detect the expected small tetragonal distortion of the FeNi lattice of c/a=1.003.

In a first experiment, four FeNi samples processed by annealing were studied. The post deformation annealing process was as described in Example 1. Two samples of cryomilled and annealed FeNi(Ti), one sample of cold-rolled and annealed FeNi, and one sample of cold-rolled and annealed FeNi(Ti). It was confirmed that all four annealed FeNi samples exhibited tetragonality on the order of c/a=1.003.

Subsequent experiments were carried out using the HRPD to examine four samples of unprocessed FeNi: commercial Alpha-Aesar FeNi powder, melt-spun FeNi(Ti) ribbons, FeNi bulk pieces cut from an FeNi ingot fabricated by drop-casting and homogenized for 100 h at 500° C. (starting material for the cold rolled and annealed FeNi), and FeNi(Ti) bulk pieces that were cut from an FeNi(Ti) ingot fabricated by drop-casting and homogenized for 100 h at 500° C. (starting material for the cold rolled and annealed FeNi(Ti)). All four unannealed samples exhibited the undistorted cubic structure. The results confirmed that long term post-synthetic annealing at below the chemical ordering temperature allowed the development of tetragonal FeNi phase.

This application claims the priority of U.S. Provisional Application No. 62/044,564 filed on 2 Sep. 2014 and entitled “RARE-EARTH-FREE PERMANENT MAGNETIC MATERIAL BASED ON Fe—Ni”, and of U.S. Provisional Application No. 62/168,329 filed on 29 May 2015 and entitled “HIGH STRAIN PROCESSING ROUTES TO TETRAGONALITY IN FeNi FOR PERMANENT MAGNET APPLICATIONS”, both of which are hereby incorporated by reference.

As used herein, “consisting essentially of” does not exclude materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein.

What is claimed is:

1. A method of making a magnetic FeNi ordered compound, the method comprising the steps of:
(a) preparing a melt comprising Fe, Ni, and optionally one or more elements selected from the group consisting of Ti, V, Al, B, and C, wherein the ratio of elements in the melt is according to the formula Fe_{(0.5-a)}Ni_{(0.5-b)}X_{(a+b)}, wherein X is Ti, V, Al, B, or C, and wherein 0≦(a+b)<0.1;
(b) cooling the melt to yield a solid form of an FeNi alloy material;
(c) subjecting the solid form to a severe plastic deformation process performed below a chemical ordering temperature of the desired L1₀ phase to yield a deformed FeNi alloy material; and
(d) annealing the deformed FeNi alloy material in a reduced oxygen environment at a temperature below the chemical ordering temperature of the desired L1₀ phase for a period of time from hours to months, whereby L1₀ structure is formed to yield the magnetic FeNi ordered compound.

2. The method of claim 1, wherein the melt in step (a) consists essentially of Fe and Ni.

3. The method of claim 1, wherein the melt in step (a) consists essentially of Fe, Ni, and one or more elements selected from the group consisting of Ti, V, Al, B, and C.

4. The method of claim 1, wherein step (b) comprises melt spinning and yields a solid form comprising pieces suitable for milling.

5. The method of claim 1, wherein the severe plastic deformation process comprises mechanically milling the solid form in the presence of a surfactant and in a reduced oxygen environment to form a powder, wherein the powder comprises a plurality of particles having a size in the nanometer to micrometer range.

6. The method of claim 5, wherein the mechanical milling is carried out in the presence of a cryogen.

7. The method of claim 6, wherein the cryogen is liquid nitrogen, liquid argon, or liquid helium.

8. The method of claim 5, wherein the surfactant is oleic acid.

9. The method of claim 1, wherein the severe plastic deformation process comprises cold rolling.

10. The method of claim 1, wherein the severe plastic deformation and/or annealing steps are performed at a temperature in the range from about 310° K to about 600° K.

11. The method of claim 1, wherein the FeNi ordered compound resulting from step (d) is in a form of, or is further processed to result in a form of, a powder comprising a plurality of particles having a size in the nanometer range, or in the micrometer range, or a mixture thereof.

12. The method of claim 11, further comprising compressing the particles in the presence of a magnetic field to form a composite magnetic composition.

13. The method of claim 1, further comprising, prior to performing step (d), the step of: (c1) milling the deformed FeNi alloy from step (c) to form a powder comprising a plurality of particles having a size in the nanometer range, or in the micrometer range, or a mixture thereof.

14. The method of claim 1, wherein the annealing is carried out in the presence of a magnetic field.

15. The method of claim 14, wherein the magnetic field has a magnitude in the range from about 10 G to about 100000 G.

16. A magnetic FeNi ordered compound produced by the method of any of the preceding claims.

17. The ordered compound of claim 16, wherein at least 50% of the ordered compound by weight is in the form of L1₀ structure.

18. The ordered compound of claim 17, wherein at least 90% of the ordered compound by weight is in the form of L1₀ structure.

19. A magnetic FeNi ordered compound having the formula Fe_{(0.5-a)}Ni_{(0.5-b)}X_{(a+b)}, wherein X is Ti, V, Al, B, or C, wherein 0<(a+b)<0.1, and wherein the ordered compound comprises L1₀ structure.

20. The ordered compound of claim 19, wherein at least 50% of the ordered compound by weight is in the form of L1₀ structure.

21. The ordered compound of claim 20, wherein at least 90% of the ordered compound by weight is in the form of L1₀ structure.

22. The ordered compound of claim 19, which has a coercivity of from about 5 kOe to about 30 kOe.

23. A permanent magnet comprising the FeNi ordered compound of claim 19.
